(19) United States
(12) Patent Application Publication
(10) Pub. No.: US 2002/0106134 A1
(43) Pub. Date: Aug. 8, 2002

(54) Multiple-orientation image defect detection and correction

(76) Inventors: Thomas A. Dundon, Austin, TX (US); Albert D. Edgar, Austin, TX (US); Leland A. Lester, Austin, TX (US)

Correspondence Address: SIMON, GALASSO & FRANTZ PLC., P.O. Box 26503, Austin, TX, 78755-0503, US

(21) Appl. No.: 09/960,635

(22) Filed: Sep. 21, 2001

Related U.S. Application Data
(60) Provisional application No. 60/235,158, filed on Sep. 22, 2000.

(51) Int. Cl. G06T 5/00; G06K 9/40; G06T 5/50; G06K 9/36; G06K 9/20

(52) U.S. Cl. 382/274; 382/275; 382/263; 382/112; 382/289; 382/318

(57) ABSTRACT

A method, system, and computer readable medium are disclosed for detecting and removing defects using images captured at multiple orientations. Defects in a physical medium in which an image is formed can hamper attempts to record representations of the original image. To lessen the effects of these physical defects on captured images, multiple images are captured using multiple different orientations of the physical medium in which the image is formed. The physical defects obscure different image information when viewed from different angles. By capturing images at multiple orientations and combining these images, almost all of the desired image information from the original image can be recovered, despite imperfections in the physical medium. The present invention finds application in image capturing devices, such as flatbed scanners, photocopiers, and the like.

### CROSS REFERENCE TO RELATED APPLICATIONS

This application claims benefit under 35 U.S.C. §119 of the following U.S. provisional patent applications: Serial No. 60/235,158, entitled Multiple-Orientation Image Defect Detection and Correction, which was filed on Sep. 22, 2000.

### FIELD OF THE INVENTION

The present invention relates generally to image capturing and processing, and more particularly to detecting and correcting image defects.

### BACKGROUND OF THE INVENTION

Document copiers, facsimile machines, image scanners, optical character recognition systems, and many other modern devices depend on accurately capturing an image formed in a physical medium. Toward that end, scientists and engineers have implemented a great number of improvements in the field of image processing in general, and the acquisition of electronic images in particular.

However, even with advances in imaging technology, improved solutions to some common problems would be welcome. For example, media in which images are formed may have defects caused by various processes, such as production of the image medium, or the storage and transportation of the physical image medium. These defects are an ongoing problem for both professionals and amateurs attempting to capture high quality images using commonly available image capturing devices, such as scanners, because the defects can degrade the quality of the captured images. The propagation of defects to captured images can significantly reduce the visual appeal of the images, or make the information contained in the physical medium more difficult to interpret.

Many image processing systems do not have the facility to detect and correct defects in captured images resulting from defects in the physical medium from which the images are captured. Image processing systems that do have the capability to detect and correct defects often require special add-on hardware or modifications that may make the use of such systems more expensive than unmodified image capturing devices. It would be beneficial if imperfections and defects in image media could be corrected using commonly available, inexpensive image capturing devices.

### SUMMARY OF THE INVENTION

What is needed, therefore, is a way to detect and remove defects in captured images resulting from imperfections in a physical medium without requiring special or additional hardware for an image processing system. Accordingly, at least one embodiment of the present invention provides a method for capturing an image formed in a physical medium having imperfections. One such method comprises positioning a physical medium in relationship to an image capturing device such that the physical medium has a first orientation, and capturing at least a first captured image representative of the image formed in the medium, at the first orientation. The method further comprises positioning the physical medium in relationship to the image capturing device such that the physical medium has a second orientation, different from the first orientation, and capturing at least a second captured image representative of the image formed in the physical medium, at the second orientation. Additionally the method comprises analyzing the captured images to identify portions of the captured images corresponding to imperfections in the physical medium, and forming a corrected image by removing, at least in part, the identified portions of the captured images corresponding to imperfections in the physical medium. Another method according to an embodiment of the present invention comprises positioning the physical medium in relationship to the image capturing device at least an additional time, such that the physical medium has at least a third orientation different from the first orientation and second orientation. The method further comprises capturing at least a third captured image representative of the image formed in the physical medium in at least the third orientation.

Another embodiment of the present invention provides a computer readable medium tangibly embodying a program of instructions. The program of instructions includes instructions capable of storing, at least temporarily, a first captured image representative of an image formed in a physical medium, where the physical medium has a first orientation when the first captured image is captured. The program of instructions additionally includes instructions capable of storing, at least temporarily, a second captured image representative of the image formed in the physical medium, where the physical medium has a second orientation when the second captured image is captured. The program of instructions further has instructions capable of analyzing the captured images to identify portions of the captured images corresponding to imperfections in the physical medium, and forming a corrected image by removing, at least in part, the identified portions of the captured images corresponding to imperfections in the physical medium.

Yet another embodiment of the present invention provides an image processing system comprising at least one communications interface capable of receiving information from an image capturing system. The image processing system further comprises at least one processor and memory operably associated with the processor. Additionally, the image processing system comprises a program of instructions capable of being stored in the memory and executed by the processor. The program of instructions includes instructions capable of storing, at least temporarily, a first captured image representative of an image formed in a physical medium, with the physical medium having a first orientation when the first captured image is captured. The program of instructions additionally is capable of storing, at least temporarily, a second captured image representative of the image formed in the physical medium, with the physical medium having a second orientation when the second captured image is captured. The program of instructions is further capable of analyzing the captured images to identify portions of the captured images corresponding to imperfections in the physical medium and forming a corrected image by removing, at least in part, the identified portions of the captured images corresponding to imperfections in the physical medium.

An advantage of at least one embodiment of the present invention is that equipment costs may be reduced, because common image capturing devices may be used without requiring additional hardware.

Another advantage of at least one embodiment of the present invention is that reproductions of images contained on physical media can show improved detail over the originals.

Yet another advantage of the present invention is that the quality of images reproduced from captured images can be improved over conventionally reproduced images.

### BRIEF DESCRIPTION OF THE DRAWINGS

Other objects, advantages, features and characteristics of the present invention, as well as methods, operation and functions of related elements of structure, and the combinations of parts and economies of manufacture, will become apparent upon consideration of the following description and claims with reference to the accompanying drawings, all of which form a part of this specification, wherein like reference numerals designate corresponding parts in the various figures, and wherein:

FIG. 1 is a block diagram of an image processing system according to one embodiment of the present invention;

FIG. 2 is a diagram illustrating a preferred embodiment of an image capturing system according to at least one embodiment of the present invention;

FIG. 3 is a cross-sectional diagram of a physical medium having a first orientation, and illustrating how defects can cause a loss of image information in captured images;

FIG. 4 is a cross-sectional diagram of the physical medium shown in FIG. 3, except at a different orientation, and illustrating how, as a result of having a different orientation, the same defect can cause a loss of a different portion of image information during an image capture according to one embodiment of the present invention;

FIGS. 5 and 6 are diagrams illustrating two different orientations of a physical medium on a platen of an image capturing device according to one embodiment of the present invention;

FIG. 7 is a top view of a media holder according to one embodiment of the present invention;

FIGS. 8 and 9 are flowcharts illustrating a method according to one embodiment of the present invention;

FIGS. 10 and 11 are diagrams illustrating two different orientations of a physical medium illuminated by a light source according to one embodiment of the present invention;

FIG. 12 is a diagram of a defect map according to one embodiment of the present invention

FIGS. 13 and 14 are histograms illustrating pixel intensity when a physical medium is illuminated in two different orientations according to one embodiment of the present invention;

FIG. 15 is a histogram illustrating a maximum pixel intensity for a pixel location according to one embodiment of the present invention;

FIG. 16 is a histogram illustrating a minimum pixel intensity for a pixel location according to one embodiment of the present invention;

FIG. 17 is a histogram illustrating the subtraction of the maximum pixel intensities from the minimum pixel intensities according to one embodiment of the present invention; and

FIG. 18 is a histogram illustrating a defect region according to one embodiment of the present invention.

### DETAILED DESCRIPTION OF THE INVENTION

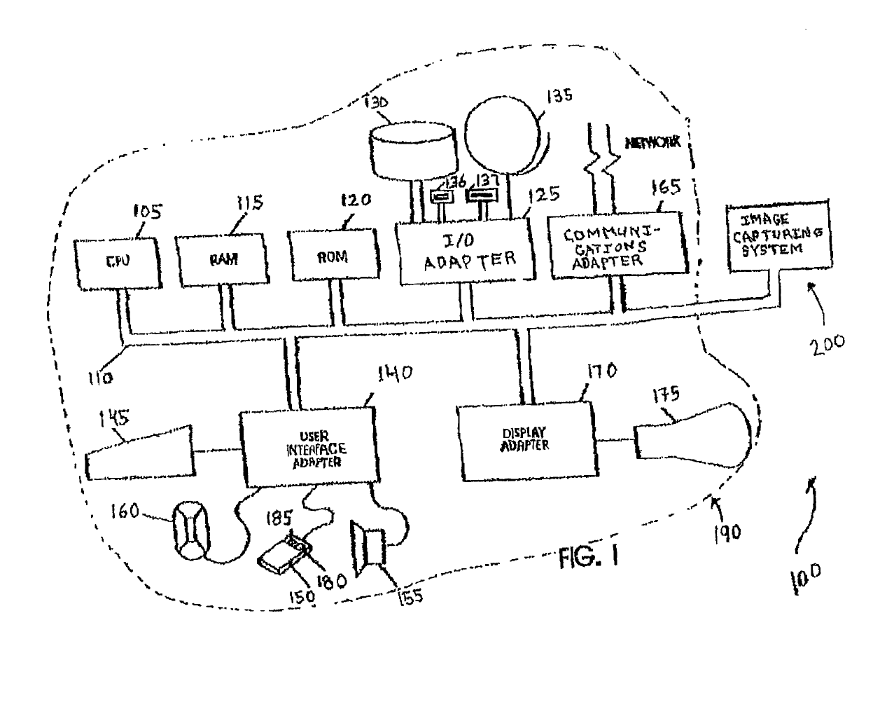

FIGS. 1-18 illustrate a system and method that can be used to detect and remove defects from images as described in greater detail below. A method according to the present invention makes use of two or more different orientations of a physical medium with respect to the light source of an image capturing system, to detect and correct defects in the physical medium that have propagated to the captured images. The physical medium may be rotated to different orientations manually, by use of an automated mechanism, or by other appropriate methods, and images representing each orientation of the physical medium can be recorded. The defects are detected using differences between two or more captured images resulting from the uneven surface of defects in the physical medium. Since multiple images are recorded at different orientations, the detected defects in the resulting image can be corrected by combining image information from the different images.

The word “light,” as used herein, refers to electromagnetic energy, and preferably electromagnetic energy with frequencies generally in the range of 10¹² Hz to 10¹⁷ Hz, and includes visible light, which is generally in the range of 4×10¹⁴ Hz to 7×10¹⁴ Hz (or approximately 430 nm to 750 nm) as well as portions of the infrared and ultraviolet spectrum. The word “defect,” as used herein, refers to an imperfection on or in the physical medium, which can be, but is not limited to, a scratch, a crease, a fold, or dust on the surface of the physical medium. The word “defect” may also refer to imperfections on or in the scanning equipment, such as scratches, smudges, fingerprints, or dust on the platen. Other characteristics of a physical medium or scanning equipment that can obscure or distort a captured image of the physical medium may also be considered “defects.” For example, matte finishes on photographs, while not imperfections, tend to produce lines in a digital image when scanned, and therefore may also be considered to be a “defect” in the physical medium. The word “orientation,” as used herein, refers to the angular position of the physical medium relative to a point of reference such as the platen of a scanning device or the scanning device itself. The term “image capturing system” refers to a combination of hardware and software used to capture images representing a physical medium and store them in an appropriate manner. The term “processing system” refers to a combination of hardware and software that is used to manipulate electronic images captured by the aforementioned image capturing system to suit the preferences of the user. The term “image processing system” is used to refer to a system that may include an image capturing system and a processing system.

An image processing system 100 according to one embodiment of the present invention is depicted in FIG. 1, and comprises processing system 190 and image capturing system 200. Processing system 190 comprises a central processing unit (CPU) 105, such as a conventional microprocessor, and a number of other units interconnected via at least one system bus 110. In one embodiment, processing system 190 and image capturing system 200 are separate systems interconnected for functionality. For example, processing system 190 may be a desktop computer, and image capturing system 200 may be a flatbed scanner. In this example, the scanner is configured to depend upon the desktop computer for image processing and control functions. In another embodiment, processing system 190 and image capturing system 200 are part of a single physical unit, such as a xerographic reproduction machine, a facsimile machine, an optical character recognition system, a flatbed scanner, etc.

One embodiment of processing system 190 is shown in FIG. 1. In this embodiment, processing system 190 is shown as an integral part of image processing system 100, and includes random access memory (RAM) 115, read-only memory (ROM) 120 wherein the ROM 120 could also be erasable programmable read-only memory (EPROM) or electrically erasable programmable read-only memories (EEPROM), and input/output (I/O) adapter 125 for connecting peripheral devices such as disk units 130, tape drives 135, CD recorders 136, or DVD recorders 137 to system bus 110, a user interface adapter 140 for connecting keyboard 145, mouse 150, speaker 155, microphone 160, and/or other user interface devices to system bus 110, communications adapter 165 for connecting processing system 190 to an information network such as the Internet, and display adapter 170 for connecting system bus 110 to a display device such as monitor 175. Mouse 150 has a series of buttons 180, 185 and is used to control a cursor shown on monitor 175. Image processing system 100 includes both processing system 190, and image capturing system 200. It will be understood that processing system 190 may comprise other suitable data processing systems without departing from the scope of the present invention.

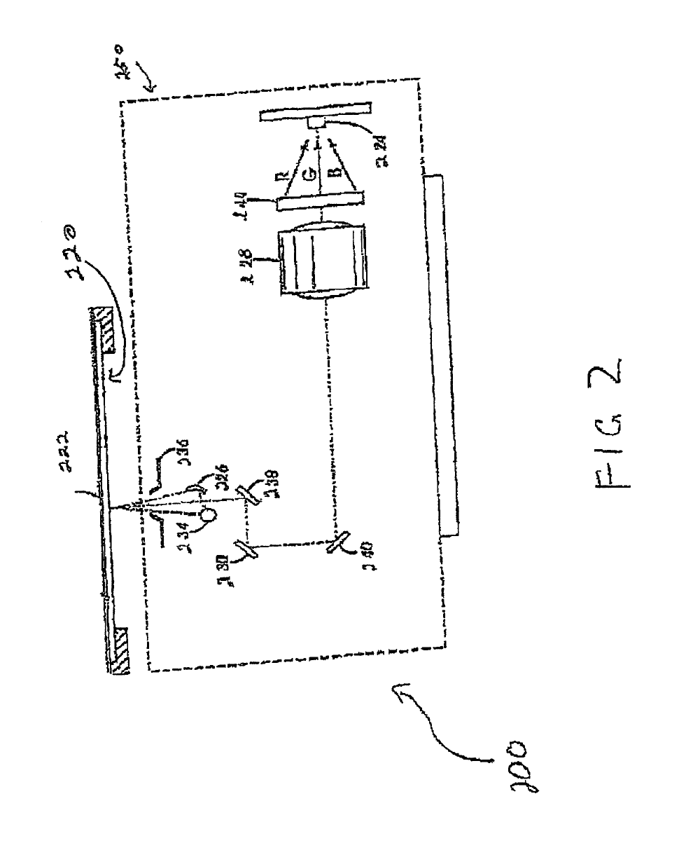

Referring next to FIG. 2, image capturing system 200 is illustrated according to one embodiment of the present invention. Image capturing system 200 incorporates a transparent platen 220 on which a physical medium 222 to be copied can be located. In one implementation, one or more arrays 224 are supported for reciprocating scanning movement below platen 220. In yet another implementation, additional arrays (not shown for ease of illustration) may be positioned above and below platen 220, and may or may not be configured to move along platen 220. A scanning system assembly 250 includes several optical components, which may move together as a single unit. In one embodiment, the scanning system assembly 250 includes a light source 234, an associated reflector 226 and a baffle 236, with the latter two elements cooperating to direct a narrow band of light onto a small area across the platen 220. Also included in the assembly 250 is lens 228, and mirrors 230, 238 and 240, which operate together to focus the light band reflected from the document being scanned, through lens 228 and filter 244, and onto array 224. Array 224 is shown as a single item for simplicity. In actual practice it is compose of at least three sensors each with a corresponding filter specific to a color, red, green, or blue. Array 224 produces electrical image signals representative of physical medium 222. These signals may be output to disk units 130, tape units 135, RAM 115, display adapter 170 for display on monitor 175, or to another device coupled to processing system 190 via a network for image processing.

Array 224 may be a linear array of photosensitive sensors such as charge coupled devices, photo-diodes, complementary metal-oxide semiconductor (CMOS) devices, or any suitable photodetector that operates to sense light reflected from or transmitted through an image formed in physical medium 222 during the illumination period. The photosensitive sensors produce electrical signals indicative of the amount of light sensed. These electrical signals may be output for use by CPU 105 in assimilating an electronically stored representation of physical medium 222, or measurement of an attribute of physical medium 222 such as image density. Array 224 generally extends in a direction transverse to that of the motion of scanning system assembly 250. This enables scanning system assembly 250 to move along an axis known to those skilled in the art as the “slow scan” axis, which begins at one end of physical medium 222 and extends in the process direction toward the opposite end. The direction across the page in which the array extends is known as the “fast scan” axis. It will be appreciated that, in some cases, only some parts of image capturing system 200, such as mirrors 230, 238, 240 are the only parts that may move in the process of scanning a physical medium. Additionally, it will be appreciated that movement of scanning system assembly 250 is described relative to a document being scanned, and that the physical medium may be moved rather than the scanning assembly. Therefore, while reference might be made herein to “movement” of one or more specific system elements and/or in a particular manner, any such references include any relative repositioning of applicable elements whereby capturing is provided in a manner consistent with at least one embodiment of the present invention.

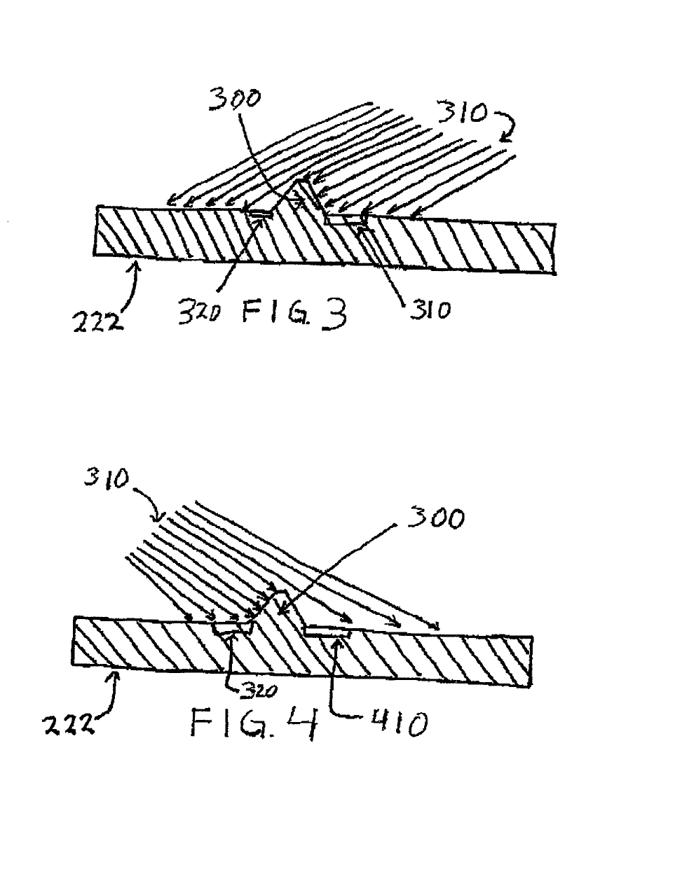

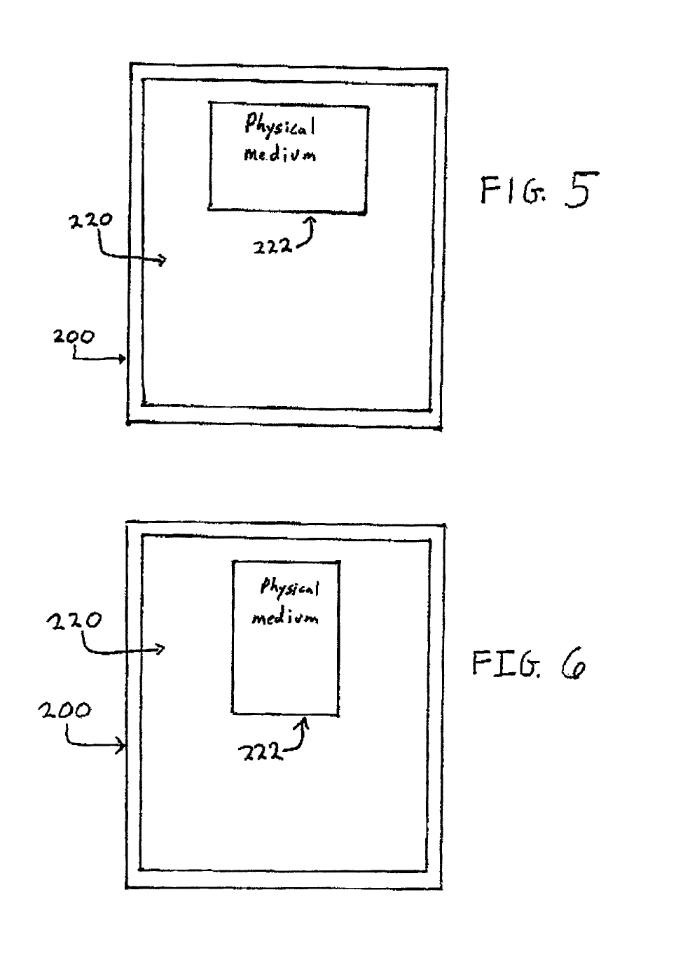

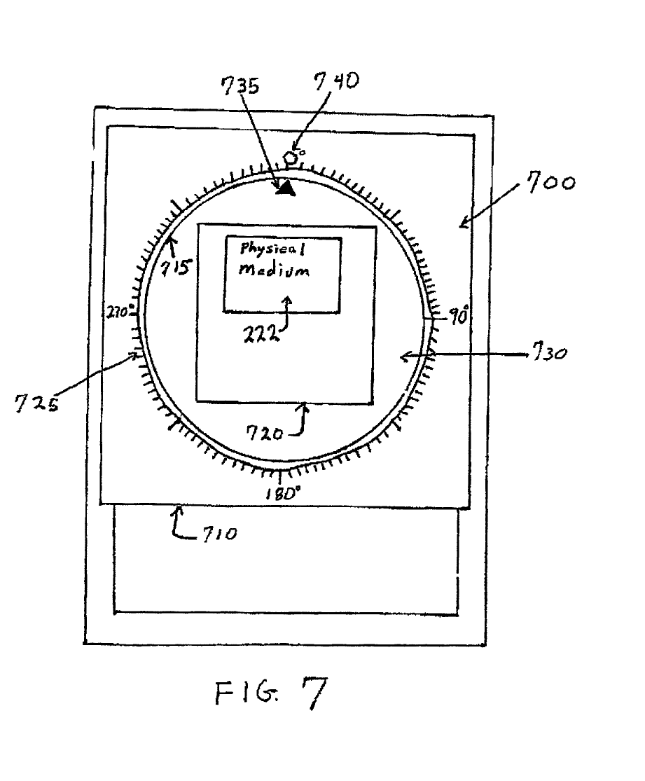

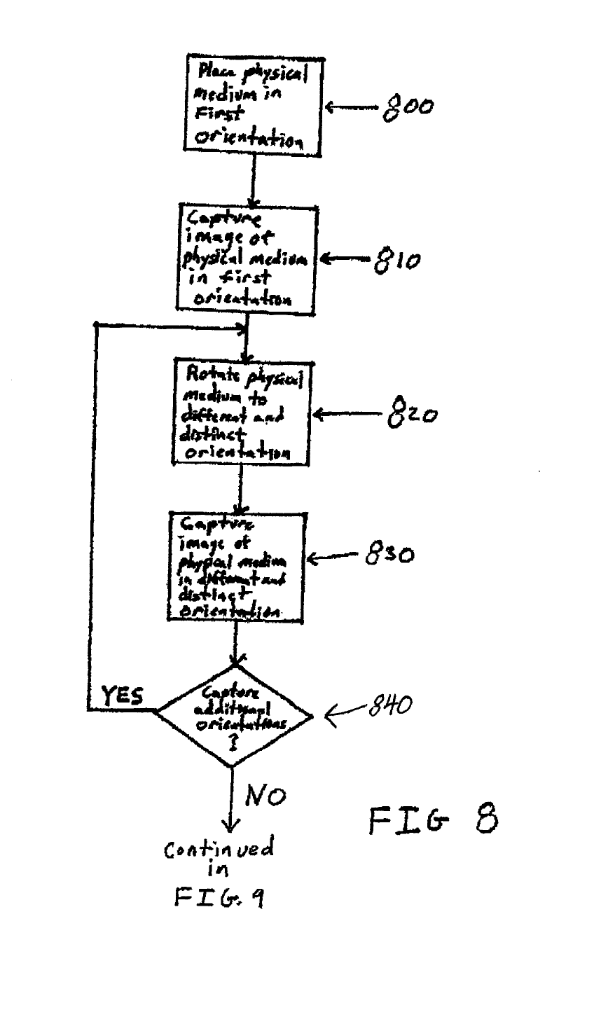

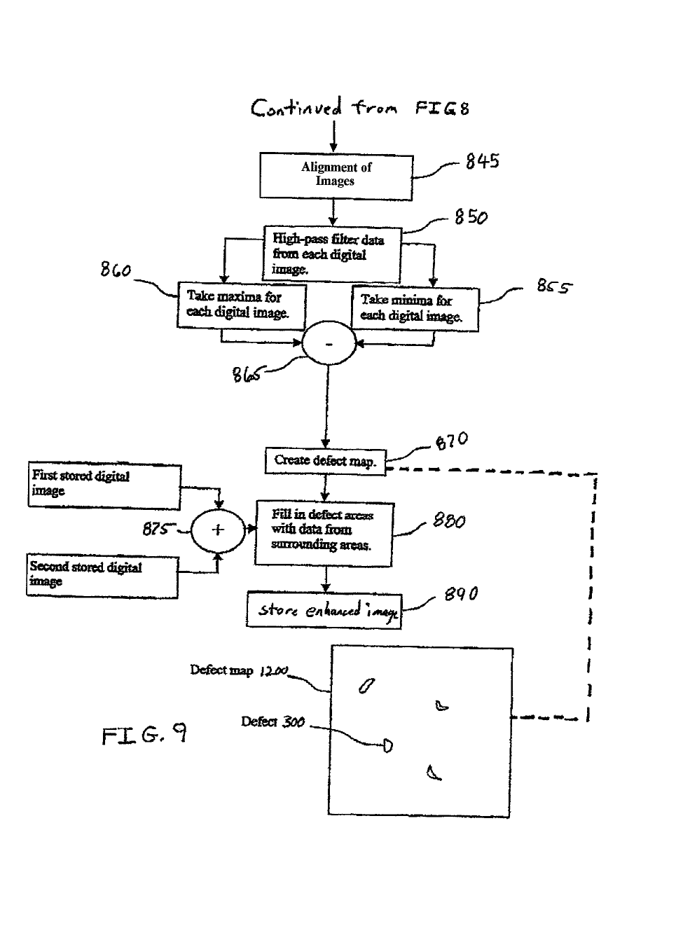

Referring to FIGS. 3 and 4, the interaction of light with a physical defect in an image containing medium is discussed. In FIG. 3, physical medium 222 is positioned in a first orientation. Light 310 emitted from light source 234 of the image capturing system 200 (as shown in FIG. 2) is reflected by physical medium 222 and is captured by the image capturing system 200 as discussed earlier. The raised surface of defect 300, in effect casts a shadow that prevents light 310 from reaching first area 320. Since light 310 is not reflected from first area 320, the captured image does not have a complete representation of physical medium 222 in first area 320. When physical medium 222 is positioned in a second orientation as shown in FIG. 4, defect 300 no longer prevents light 310 from light source 234 from illuminating first area 320. However, in the second orientation, defect 300 prevents light 310 from reaching second area 410, thereby obscuring a different area of physical medium 222 than was obscured when physical medium 222 was positioned in the first orientation. By capturing images at multiple orientations of physical medium 222, substantially all of the image information can be recorded, even image information that would normally be obscured by defect 300. Light 310 reflected from the top of defect 300 may also have special characteristics, and this information may be used to detect and correct defects. In effect each captured image contains information about the physical medium that the other images may lack. The information that the two images contain may be combined to remove the effects of defect 300 to produce a resultant image with fewer defects. Note that the change in orientation of physical medium 222 is relative to the light source 234, but in fixed illumination source systems, the orientation of physical medium 222 can be changed by moving physical medium 222 relative to an image capturing system 200. Physical medium 222 may be positioned in particular orientations by employing one or more of the methods discussed below, as well as other suitable methods which will become apparent upon consideration of this disclosure.

In order to clarify what is meant by an image orientation, refer to FIGS. 5 and 6, in which a physical medium is illustrated in two different orientations. In FIG. 5, physical medium 222 is placed on platen 220 of image capturing system 200 in a first orientation. An image representing physical medium 222 in the first orientation may be captured and stored in image processing system 100. Physical medium 222 is then rotated to a second orientation, as illustrated in FIG. 6 and a second image representing physical medium 222 (illustrated in FIG. 6) in the second orientation is captured. This second orientation of physical medium 222 is distinct from the initial orientation of physical medium 222, as well as any subsequent orientations. The angle of change in orientation with respect to the first orientation may be any angle different from the first orientation, but easily attainable angles, such as 90°, 120°, or 180° are used in at least one embodiment. In the embodiment of the present invention illustrated in FIGS. 5 and 6, the physical medium is rotated manually from the first orientation in FIG. 5 to the second orientation in FIG. 6. In other embodiments, the physical medium may be rotated to different orientations using an automated mechanism.

In at least one embodiment of the present invention, the program of instructions for detecting and correcting defects provides the ability to compensate for errors in the accuracy of the orientation angle introduced by the manual or automatic orienting of physical medium 222. For example, a user or the image defect detection and correction software may dictate a difference of 90° between image captures of physical medium 222 in a first orientation and a second orientation. However, human or mechanical error causes a difference of only 85° between the first orientation and second orientation. Since the error between the desired difference angle (90°) and the actual difference angle (85°) is within the compensation range (for example ±5°) of the image defect detection and correction software, therefore the software is capable of compensating for this error. Although a compensation range of ±5° is discussed, other compensation ranges may be used without departing from the spirit or the scope of the present invention.

Referring to FIG. 7, one embodiment of an automated positioning mechanism is illustrated, and designated generally as media holder 700. Media holder 700 incorporates chassis 710, rotating carriage 730, transparent platen 720, and channel 715. In at least one embodiment of the present invention, media holder 700 may be an integral element of image capturing system 200 (FIG. 2). Alternatively, media holder 700 may be a device that can be placed on a conventional image capturing device such as a scanner, copier, optical character recognition system, and the like. Media holder 700 rotates physical medium 222 located on transparent platen 720, which is in turn located in rotating carriage 730, by a desired angle relative to the orientation of a previous image capture. In use, media holder 700 is placed on platen 220 of image capturing system 200 (FIG. 2). Physical medium 222 is placed on transparent platen 720, which is in turn located in the rotating carriage 730. Rotating carriage 730 is connected to chassis 710 by means of channel 715, allowing rotating carriage 730 and transparent platen 720 to rotate about the central axis of rotating carriage 730. Tick marks 725 indicating degree of rotation from point 740 are located on the surface of chassis 710 proximal to rotating carriage 730. Position indicating mark 735, located on the surface of the rotating carriage 730, is used to indicate relative orientation from point 740 using tick marks 725. Alternatively, one may practice the present invention by rotating the image capturing system 200 in relation to the physical medium 222 thus causing a change in the orientation of physical medium 222 to image capturing system 200 between image captures. Other suitable methods of positioning physical medium 222 at different orientations may be applied consistent with the principles set forth herein.

Referring next to FIGS. 8 and 9, a method of practicing at least one embodiment of the present invention is illustrated. The method commences at step 800, where physical medium 222 is placed on platen 220 of image capturing system 200 (as shown in FIG. 2) in a first orientation. Alternatively, if the use of a mechanism to rotate the physical medium is desired by the user, physical medium 222 can also be placed on transparent platen 720 of media holder 700 (as shown in FIG. 7). In step 810, an image of physical medium 222 in the first orientation is captured by image capturing system 200 and may be recorded in processing system 190. As noted earlier, in at least one embodiment, both image capturing system 200 and processing system 190 are part of image processing system 100. The method then proceeds to step 820. In step 820 physical medium 222 is rotated to a second orientation, different than the previous orientation of physical medium 222 in step 800. The second angle may be any angle different from the first angle, but easily attainable angles such as 90°, 120°, or 180° may be used in at least one embodiment. The physical medium may be rotated manually by a user, automatically positioned by a mechanism such as that shown in FIG. 7, or positioned using other suitable methods. In step 830, a second image of physical medium 222 in a second orientation is captured and stored in the same manner as the first image was captured in step 810. The decision to capture additional images of physical medium 222 is made in step 840. Additional images may be used to improve the quality of a desired image by providing additional image information that may be used in combination with the first image and the second image to improve the resultant image's resolution, improve defect detection and removal, or otherwise facilitate image reproduction.

If additional images of physical medium 222 are to be captured, steps 820-840 may be repeated the desired number of times until all desired images of physical medium 222 in the desired number of different orientations are captured. As noted earlier, the additional orientations may be any angle different from the angles of the previous orientations of physical medium 222, but easily attained angles, such as 90°, 120°, and 180° may be used. While it is desirable to capture images at different orientations, some embodiments of the present invention record multiple images at a single orientation, in addition to capturing images at different orientations. If no additional images are to be captured, the method proceeds to step 850, illustrated in FIG. 9.

Note that in at least one embodiment, images are captured and processed using data sets obtained from a plurality of pixels detected by a image capturing device. A pixel is the smallest individual, discrete element of a captured image. For color images, scanned pixels generally contain multiple samples; one for each color sub-sample, such as red, green and blue. Often each pixel is represented in the image processing system by a plurality of bits. Typically, the intensity or frequency of a pixel is represented by an 8 bit byte. The greater the number of pixels per unit area, the greater clarity, or resolution, of the captured image. The plurality of pixels representing a captured image are represented by a data set that can be processed by an image processing system to detect and correct defects, alter coloring, and the like.

Referring next to FIG. 9, a continuation of the flowchart depicted in FIG. 8 is illustrated according to one embodiment of the present invention. Step 845 aligns the two or more digital images so that data from corresponding pixels may be examined and compared. In step 850, image processing system 100 filters the digital data in the data sets for the two or more digital images captured from physical medium 222 in two or more different orientations in steps 800 to 840 (FIG. 8). In many applications, image processing system 100 may use a high-pass filter for filtering. The purpose of the filter is to reduce the effects of irregular light source shading. A variety of filters are known to reduce the effects of irregular light source shading. A useful filter is the difference between the original image and the low pass version of the image created through a Gaussian filter with a radius of five pixels.

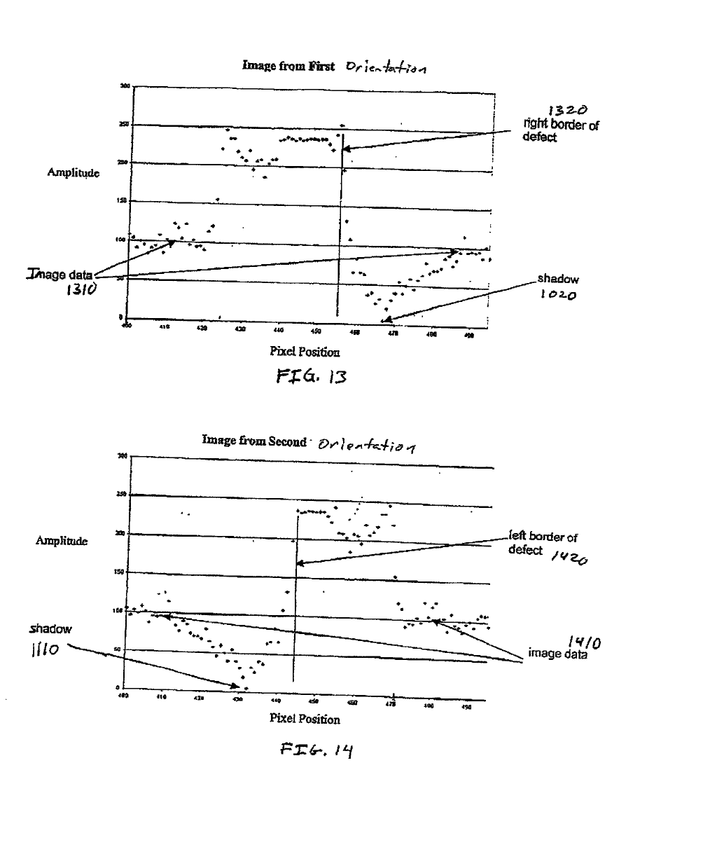

Once the data has been filtered, in steps 855 and 860, the minima and maxima of the two corresponding pixels of each of the two captured digital images are obtained. The corresponding pixels are the pixels that are sensed from substantially the same physical location on the substrate. The maxima is the highest pixel intensity of the pixel pairs and the minima is the lowest pixel intensity of the pixel pairs. In cases where color sub-samples are captured, each pixel would have a corresponding pixel intensity value for each color. For example, if red, green, and blue samples are captured, there would be pixel intensity values for each of the red, green, and blue sample captures. In steps 855 and 860, image processing system 100 finds the maximum and minimum amplitude intensity for the pixel pairs. By obtaining the maxima and minima, it is possible to obtain histograms of the maximum and minimum amplitude intensity. An example of these histograms are illustrated in FIGS. 15 and 16, which will be discussed later.

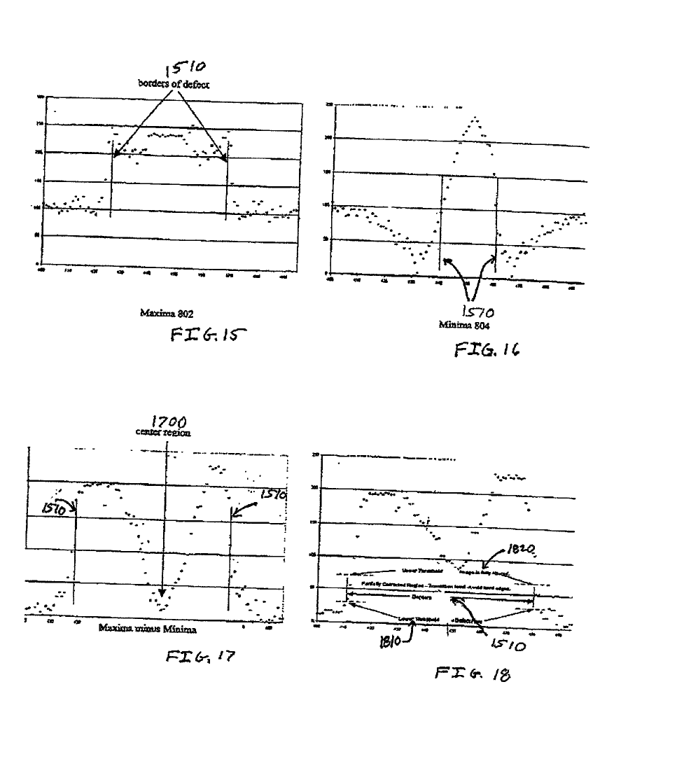

In step 865, the difference between the maximum and minimum pixel intensity for each pixel is obtained. Using this difference, it is possible to create a histogram of the difference between a maximum and a minimum amplitude intensity. Such a histogram is illustrated in FIG. 17. As is apparent from the histogram in FIG. 17, the difference between the minimum and the maximum is center region 1700 having a small difference value which corresponds to the center region of the defect, which on either side of center region 1700 will be a very large difference value. The large value difference exists due to the fact that light from each side of the pixel will cast a shadow in the opposite direction and therefore the difference between the minimum and the maximum pixel intensity on the opposite side of the defects will be large. Note that the operations of steps 855, 860, and 865 can be implemented in a variety of different manners of those skilled in the art. It will be appreciated that the maximum of the two pixels minus the minimum of the two pixels is equivalent to the absolute value of one pixel minus the other.

In step 870, the differences of each pixel are used to create a defect map in which adjacent pixels, each indicative of a defect at the pixel level, are combined to form a region of pixels corresponding to a single defect. A method of creating a defect map according to one embodiment of the present invention is discussed elsewhere with reference to FIGS. 10, 11, and 12. As can be seen in the difference between the histograms in FIGS. 17 and 18, clusters of pixels may be operated upon, such that the maximum pixel difference value in the cluster will be assigned to all the pixels in the cluster, so long as the pixel values do not exceed a lower threshold value 1810 such as an amplitude of 35. The lower threshold value 1810 is used to indicate that if a pixel has a value below that threshold it does not contain a defect. Lower threshold value 1810 is empirically determined. Thus, the usage of this regional maximum tends to linearize the image portion of the histogram in FIG. 18 and also provides for more accurate borders 1510 of the defect to be established. For example, the first three pixels in FIG. 17 have different amplitude values, by considering these pixels to be part of the same cluster, they may be assigned the same pixel value. This can be seen by examining the first three pixels of FIG. 18. These pixels now have the same intensity value. This allows for differences in amplitudes to be determined more accurately and therefore leads to a more accurate determination of defect borders.

The area between the thresholds, considered to contain a partial defect, will be partially corrected, to avoid hard edges, as described below. While upper threshold value, with an amplitude of 75, and lower threshold value 1810, with and amplitude of 35, have been found useful, other values can be used. It should be noted, therefore, that the defect map contains information not only relating to the presence or absence of defects but to the degree to which a defect exists. This helps, as will be appreciated by those skilled in the art, in blending together regions that do not contain a defect. While FIGS. 13-18 illustrate the use of histograms to locate defects, the information can also be stored and arranged in a record, file or by other convenient means.

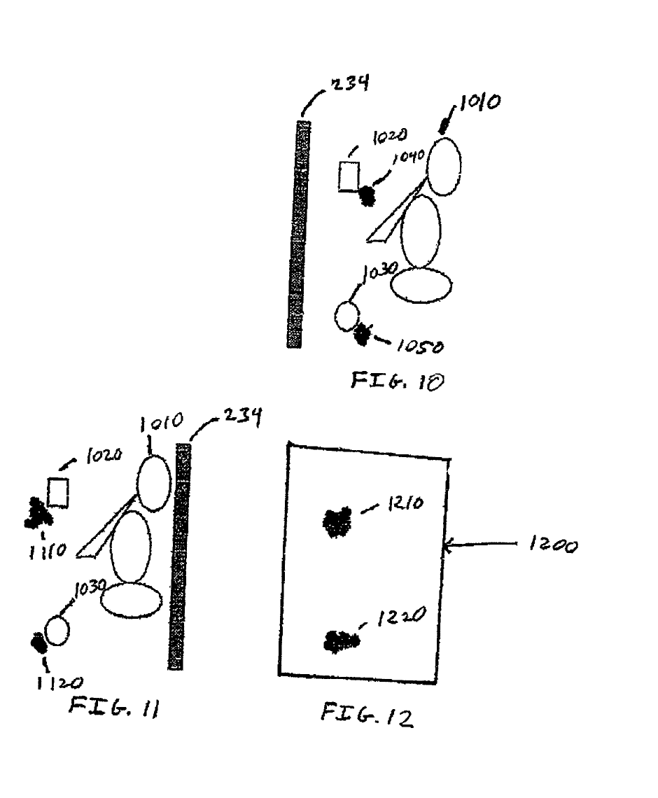

In determining defect map 1200 (FIG. 12), at least one embodiment of the present invention also applies an upper threshold value 1820 (FIG. 18) to the difference data to obtain a mask of the areas that correspond to a defect. Thus, all pixel locations that have a difference value that is greater than the upper threshold value 1820, which in this example is 75, will be considered to contain a true defect and can be fully corrected as described according to at least one embodiment of the present invention.

Next, in step 875, information from the digital image of physical medium 222 in a first orientation and the digital image of physical medium 222 in a second orientation captured in steps 800-840 is combined to provide data for defect areas on defect map 1200. In step 880 this information is used to fill in defect areas detected using defect map 1200. Data from the surrounding areas of defect 300 in defect map 1200 in the captured images is used to fill in missing information for defect 300 in defect map 1200. Additional image captures may provide additional data for areas of physical medium 222 (FIG. 2) affected by defects, contamination, artifacts, or other image imperfections.

The method concludes in step 890, where the resulting enhanced image with corrected defects from steps 800-880 is stored in a computer readable form using processing system 190. Alternatively, the resulting image can be reproduced as a physical medium, such as a printed image or on film, transmitted via an external network such as the Internet, delivered as an electronic mail attachment, displayed on a computer monitor, or otherwise. It should be noted that defect detection and correction results may vary depending on the hardware and software components used in image processing system 100. For example, low-end scanners (image capturing device 200) may not have the ability to capture images at a resolution that allows very small defects to be detected, and therefore these very small defects may not be corrected. Similarly, processing system 190, such as a personal computer, with minimal or substandard processing power may be unable to process multiple images of a physical medium to detect and correct defects in a time considered reasonable by a user. It should also be noted that while FIGS. 8 and 9 illustrate a particular sequence of steps, other methods of practicing the present invention employ variations in the order of the illustrated steps.

A method for creating a defect map for use in detecting and correcting defects according to one embodiment of the present invention is depicted in FIGS. 10, 11 and 12. Referring first to FIG. 10, an image 1010 on physical medium 222 in a first orientation with a first defect 1020 and a second defect 1030, such as a piece of dirt, a smudge, or a scratch, is illustrated. Also illustrated is light source 234 of image capturing system 200 (FIG. 2) on the left side of physical medium 222 in a first orientation. Light source 234 illuminates physical medium 222 and first defect 1020 and second defect 1030 at an angle from the left hand side. This produces a first defect shadow 1040 and a second defect shadow 1050 to the right of first defect 1020 and second defect 1030. No shadow is produced by image 1010 since it is flat on physical medium 222.

Referring next to FIG. 11, an image 1010 on physical medium 222 in a second orientation different from the first orientation of FIG. 10 by 180° with a first defect 1020 and a second defect 1030 is illustrated. Light source 234 is on the right hand side of physical medium 222 due to the 180° change in orientation from the first orientation of FIG. 10 to FIG. 11. Light source 234 illuminates image 1010 and first defect 1020 and second defect 1030 at an angle from the right hand side. This produces a first defect shadow 1110 and a second defect shadow 1120 to the left of first defect 1020 and second defect 1030. No shadow is produced by image 1010 since it is flat on physical medium 222.

Referring next to FIG. 12, an illustration of the shadows of the defects isolated from the image in the creation of a defect map according to one embodiment of the present invention is discussed. The results of the image captures of physical medium 222 (FIG. 2) in a first orientation and a second orientation in FIGS. 10 and 11 are combined and processed by image processing system 100 according to a method detailed in at least one embodiment of the present invention. The results isolate the defects (1210, 1220) into defect map 1200 that can be used to identify and correct defects in image 1010 according to at least one embodiment of the present invention.

Referring to FIG. 13, a spatial histogram showing digital data captured in response to the illumination of physical medium 222 (FIG. 2) in a first orientation is discussed according to one embodiment of the present invention. The histogram is plotted by pixel amplitude and by pixel position. Image data 1310 is shown as the data with amplitudes in the range of 80 to 125 for pixel positions 400 through approximately 425. Data for defect 1020 is shown as the pixel positions by approximately 435 to nearly 490 which shows an amplitude dropped in value from pixel position 450 to pixel position 468. This represents shadow 1040 which falls to the right of the defect. Shadow 1040 is typically caused when light is reflected before reaching part of an image, or is blocked before it reaches part of an image, such that the amplitude of light from a portion of the image is reduced. After position 468, the amplitude of light rises until it reaches the level of the image data again around position 480. Therefore, a right boundary 1320 for defect 1020 can be established at position 455 based on the position of shadow 1040.

FIG. 14 illustrates the data record response of physical medium 222 (FIG. 2) in a second orientation different from the first orientation of FIG. 13 by 180°. The histogram shows a reverse pattern than from the pattern shown in the previous histogram in FIG. 13. Image data 1410 is shown with an amplitude between 80 and 125 at pixel values 470 to around 500. The drop in amplitude for pixel positions after 445 to nearly pixel position 220 at pixel position 432 represents shadow 1110 falling to the left of the image cast again from defect 1020. After position 432, the amplitude rises into each level of the image data set around pixel position 420. Thus, a left boundary 1420 for defect 1020 can be established at substantially position 445 based on the shadow position.

It should be noted, with respect to FIGS. 13 and 14, that pixel intensity values that allow the creation of such histograms will be obtained for each of the colors scanned with respect to the same group of pixels. The data representing red, green, and blue, as described previously, can be used in a variety of ways, such as individually (only one of red, green, and blue from the second image used), combined together, or in dependence upon other characteristics of the image portion being scanned, such as using only red and blue in the green portion of the image and only red and green in the blue portion of the image for the purpose of creating defect map 1200 (FIG. 12).

The method of the present invention records multiple orientations of a physical image, and combines these captured images to detect and correct defects in the physical medium and create a resulting captured image having improved quality. This captured image is preferably an electronic representation of the physical image, and may be stored as a digital file embodied in a computer readable medium. The captured image contained in the digital file can then be extracted from the computer readable medium and reproduced using a suitable image output device.

In the preceding detailed description, reference has been made to the accompanying drawings which form a part hereof, and in which are shown by way of illustration specific embodiments in which the invention may be practiced. These embodiments have been described in sufficient detail to enable those skilled in the art to practice the invention, and it is to be understood that other embodiments may be utilized and that logical, mechanical, chemical and electrical changes may be made without departing from the spirit or scope of the invention. To avoid detail not necessary to enable those skilled in the art to practice the invention, the description omits certain information known to those skilled in the art.

One of the preferred implementations of the invention is as sets of instructions resident in the random access memory 115 of one or more processing systems 190 configured generally as described in FIGS. 1-8. Until required by processing system 190, the set of instructions may be stored in another computer readable memory, for example, in a hard disk drive or in a removable memory such as an optical disk for eventual use in a CD drive or DVD drive or a floppy disk for eventual use in a floppy disk drive. Further, the set of instructions can be stored in the memory of another image processing system and transmitted over a local area network or a wide area network, such as the Internet, where the transmitted signal could be a signal propagated through a medium such as an ISDN line, or the signal may be propagated through an air medium and received by a local satellite to be transferred to processing system 190. Such a signal may be a composite signal comprising a carrier signal, and contained within the carrier signal is the desired information containing at least one computer program instruction implementing the invention, and may be downloaded as such when desired by the user. One skilled in the art would appreciate that the physical storage and/or transfer of the sets of instructions physically changes the medium upon which it is stored electrically, magnetically, or chemically so that the medium carries computer readable information. The preceding detailed description is, therefore, not to be taken in a limiting sense, and the scope of the present invention is defined only by the appended claims.

What is claimed is:

1. A method for capturing an image formed in a physical medium having imperfections, the method comprising:
positioning a physical medium in relationship to an image capturing device such that the physical medium has a first orientation;
capturing at least a first captured image representative of the image formed in the medium, at the first orientation;
positioning the physical medium in relationship to the image capturing device such that the physical medium has a second orientation, different from the first orientation;
capturing at least a second captured image representative of the image formed in the physical medium, at the second orientation;
analyzing the captured images to identify portions of the captured images corresponding to imperfections in the physical medium; and
forming a corrected image by removing, at least in part, the identified portions of the captured images corresponding to imperfections in the physical medium.

2. The method as in claim 1, wherein the physical medium is positioned in the at least a second orientation by rotating the physical medium through a predetermined angle.

3. The method as in claim 1, wherein the physical medium is positioned in the at least a second orientation by rotating the physical medium 90 degrees.

4. The method as in claim 1, wherein the physical medium is positioned in the at least a second orientation by rotating the physical medium 120 degrees.

5. The method as in claim 1, wherein the physical medium is positioned in the at least a second orientation by rotating the physical medium 180 degrees.

6. The method as in claim 1, further comprising:
positioning the physical medium in relationship to the image capturing device at least an additional time, such that the physical medium has at least a third orientation, different from the first orientation and the second orientation; and
capturing at least a third captured image representative of the image formed in the physical medium, at the at least a third orientation.

7. The method as in claim 1, wherein the at least two orientations of the physical medium allow image data to be captured by the image capturing device that otherwise would be blocked, shadowed, or otherwise obscured by a defect or defects.

8. A computer readable medium tangibly embodying a program of instructions, said program of instructions including instructions capable of:
storing, at least temporarily, a first captured image representative of an image formed in a physical medium, said physical medium having a first orientation when said first captured image is captured;
storing, at least temporarily, a second captured image representative of the image formed in said physical medium, said physical medium having a second orientation when said second captured image is captured;
analyzing the captured images to identify portions of the captured images corresponding to imperfections in the physical medium; and
forming a corrected image by removing, at least in part, the identified portions of the captured images corresponding to imperfections in the physical medium.

9. The computer readable medium as in claim 8, wherein said second orientation is offset from said first orientation by a predetermined angle.

10. The computer readable medium as in claim 8, wherein said second orientation is offset from said first orientation by 90 degrees.

11. The computer readable medium as in claim 8, wherein said second orientation is offset from said first orientation by 120 degrees.

12. The computer readable medium as in claim 8, wherein said second orientation is offset from said first orientation by 180 degrees .

13. The computer readable medium as in claim 8, wherein said program of instructions is further capable of storing, at least temporarily, a third captured image representative of the image formed in s aid physical medium, said physical medium having a third orientation when said third captured image is captured.

14. An image processing system comprising:
at least one communications interface capable of receiving information from an image capturing system;
at least one processor;
memory operably associated with said processor; and
a program of instructions capable of being stored in said memory and executed by said processor; said program of instructions including instructions capable of:
storing, at least temporarily, a first captured image representative of an image formed in a physical medium, said physical medium having a first orientation when said first captured image is captured;
storing, at least temporarily, a second captured image representative of the image formed in said physical medium, said physical medium having a second orientation when said second captured image is captured;
analyzing said captured images to identify portions of the captured images corresponding to imperfections in the physical medium; and
forming a corrected image by removing, at least in part, the identified portions of said captured images corresponding to imperfections in said physical medium.

15. The image processing system as in claim 14, further comprising an image capturing system, said image capturing system capable of capturing representations of images formed in said physical medium and transmitting information associated with said captured representations through said communications interface.

16. The image processing system as in claim 15, wherein said image capturing system comprises a media holder, said media holder capable of rotating said physical medium to position said physical medium in said first orientation and said second orientation.

17. The image processing system as in claim 15, wherein said image capturing system is a scanner.

18. The image processing system as in claim 14, wherein said second orientation is offset from said first orientation by a predetermined angle.

19. The image processing system as in claim 14, wherein said second orientation is offset from said first orientation by 90 degrees.

20. The image processing system as in claim 14, wherein said second orientation is offset from said first orientation by 120 degrees.

21. The image processing system as in claim 14, wherein said second orientation is offset from said first orientation by 180 degrees.

22. The image processing system as in claim 14, wherein said program of instructions further includes instructions capable of storing, at least temporarily, a third captured image representative of the image formed in said physical medium, said physical medium having a third orientation when said third captured image is captured.
